(19) United States
(12) Patent Application Publication
(10) Pub. No.: US 2012/0081273 A1
(43) Pub. Date: Apr. 5, 2012

(54) PIXEL STRUCTURE, PIXEL ARRAY AND DISPLAY PANEL

(75) Inventors: Ya-Ling Hsu, Taipei County (TW); Peng-Bo Xi, Taipei City (TW); Hung-Lung Hou, Changhua County (TW)

(73) Assignee: AU OPTRONICS CORPORATION, Hsinchu (TW)

(21) Appl. No.: 13/040,273

(22) Filed: Mar. 4, 2011

(30) Foreign Application Priority Data
Oct. 5, 2010 (TW) 99133887

(51) Int. Cl. G09G 3/20

(52) U.S. Cl. 345/55

(57) ABSTRACT

A pixel structure, a pixel array, and a display panel are provided. The pixel structure includes a scan line, a data line, an active device, a pixel electrode, and a conductive bar pattern. The active device is electrically connected to the scan line and the data line. The pixel electrode is electrically connected to the active device. The conductive bar pattern is located on and electrically connected to the data line. The conductive bar pattern has a line width greater than or equal to a line width of the data line, and the conductive bar pattern and the pixel electrode are in the same layer.

### CROSS-REFERENCE TO RELATED APPLICATION

This application claims the priority benefit of Taiwan application serial no. 99133887, filed on Oct. 5, 2010. The entirety of the above-mentioned patent application is hereby incorporated by reference herein and made a part of this specification.

### BACKGROUND OF THE INVENTION

1. Field of the Invention

The invention relates to a pixel structure, a pixel array, and a display panel.

2. Description of Related Art

In general, a pixel structure of a liquid crystal display (LCD) includes a scan line, a data line, an active device, and a pixel electrode. In the pixel structure, the aperture ratio of the LCD can be increased if the area of the pixel structure is expanded. However, when the pixel structure is too close to the data line, the capacitance Cpd between the pixel electrode and the data line is increased. Thereby, when a switch device is in an off state, the voltage of the pixel electrode is affected by signals transmitted through the data line, which leads to a so-called crosstalk effect that poses a negative impact on display quality of the LCD.

To be more specific, in one of the pixel structures of the pixel array, a data line is often located at two sides of the pixel structure, respectively. The processes of fabricating the pixel structure with use of a plurality of photo-masks result in misalignment, and thus each layer of the pixel structure is likely to be at unexpected locations. As a result, the distance between the pixel electrode and the data lines respectively located at the two sides of the pixel electrode is different, and the coupling capacitance between the pixel electrode and the data lines respectively located at the two sides of the pixel electrode is not equal. That is to say, due to variations in signals on the data lines, the voltage level of the pixel electrode is not pulled up or down to the same extent. Hence, the voltage level of the pixel electrode does not remain unchanged, the gray-scale display performance of the display panel is influenced, and the V-crosstalk effect is then generated.

### SUMMARY OF THE INVENTION

The invention is directed to a pixel structure, a pixel array, and a display panel. By applying the invention, the V-crosstalk effect of the display panel can be mitigated.

The invention provides a pixel structure that includes a scan line, a data line, an active device, a pixel electrode, and a conductive bar pattern. The active device is electrically connected to the scan line and the data line. The pixel electrode is electrically connected to the active device. The conductive bar pattern is located on and electrically connected to the data line. The conductive bar pattern has a line width greater than or equal to a line width of the data line, and the conductive bar pattern and the pixel electrode are in the same layer.

The invention provides a pixel array that includes a plurality of scan lines, a plurality of data lines, a plurality of active devices, a plurality of pixel electrodes, and a plurality of conductive bar patterns. Each of the active devices is electrically connected to one of the scan lines and one of the data lines. Each of the pixel electrodes is electrically connected to one of the active devices. Each of the conductive bar patterns is located on and electrically connected to one of the data lines. The conductive bar patterns have a line width greater than or equal to a line width of the data lines, and the conductive bar patterns and the pixel electrodes are in the same layer.

The invention provides a display panel that includes a first substrate, a second substrate, and a display medium. The first substrate includes the aforesaid pixel array. The second substrate is located opposite to the first substrate. The display medium is located between the first substrate and the second substrate.

Based on the above, the conductive bar patterns are located on and electrically connected to the data lines. The conductive bar patterns and the pixel electrodes are in the same layer, and the coupling capacitance is generated not only between the pixel electrodes and the data lines located at respective sides of the pixel electrodes but also between the pixel electrodes and the conductive bar patterns located on the data lines. As such, the difference in the coupling capacitance between the pixel electrodes and the data lines located at the respective sides of the pixel electrodes can be reduced, and the V-crosstalk effect of the display panel can be further mitigated.

In order to make the aforementioned and other features and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view illustrating a pixel array according to an embodiment of the invention.

FIG. 2 is a schematic cross-sectional view taken along a sectional line A-A′ depicted in FIG. 1.

FIG. 3 is a schematic top view illustrating a pixel array according to an embodiment of the invention.

FIG. 4 is a schematic cross-sectional view taken along a sectional line B-B′ depicted in FIG. 3.

FIG. 5 is a schematic view illustrating a display panel according to an embodiment of the invention.

### DETAILED DESCRIPTION OF EMBODIMENTS

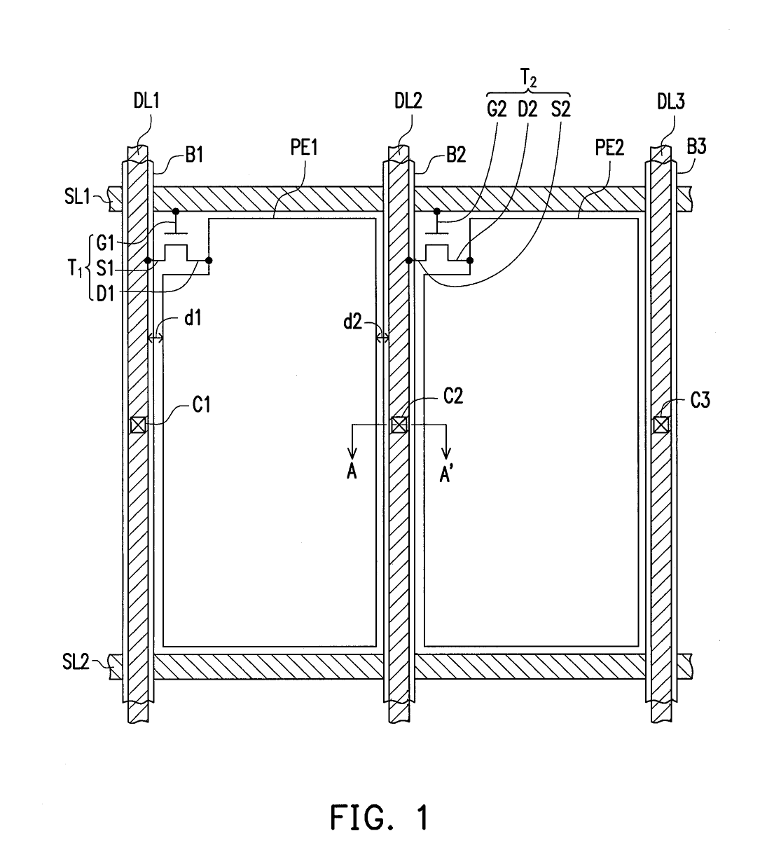

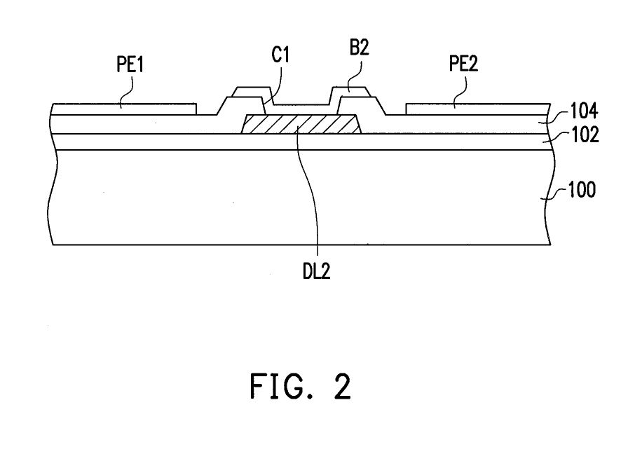

FIG. 1 is a schematic top view illustrating a pixel array according to an embodiment of the invention. FIG. 2 is a schematic cross-sectional view taken along a sectional line A-A′ depicted in FIG. 1. With reference to FIG. 1 and FIG. 2, the pixel array of this embodiment includes a plurality of data lines DL1˜DL3, a plurality of scan lines SL1˜SL2, a plurality of active devices T1 and T2, a plurality of pixel electrodes PE1 and PE2, and a plurality of conductive bar patterns B1˜B3. In general, the pixel array comprises a plurality of pixel structures. To elaborate this embodiment, the pixel array depicted in FIG. 1 only has two of the pixel structures. As a matter of fact, the pixel array is constituted by a plurality of pixel structures arranged in arrays.

The scan lines SL1˜SL2 and the data lines DL1˜DL3 are configured on the substrate 100. The scan lines SL1˜SL2 and the data lines DL1˜DL3 are intersected, and an insulating layer 102 is sandwiched between the scan lines SL1˜SL2 and the data lines DL1˜DL3. In other words, extending directions of the data lines DL1˜DL3 are not parallel to extending directions of the scan lines SL1˜SL2, and it is favorable for the extending directions of the data lines DL1˜DL3 to be substantially perpendicular to the extending directions of the scan lines SL1˜SL2. Moreover, the scan lines SL1˜SL2 and the data lines DL1˜DL3 are in different layers. In consideration of electrical conductivity, the scan lines SL1˜SL2 and the data lines DL1˜DL3 are typically made of metallic materials. However, the invention is not limited thereto. In other embodiments of the invention, the scan lines SL1˜SL2 and the data lines DL1˜DL3 can also be made of other conductive materials. The metallic material is, for example, an alloy, metal nitride, metal oxide, metal oxynitride, another appropriate material, or a layer in which the metallic material and any other conductive material are stacked to each other.

The active devices T1 and T2 are electrically connected to one of the scan lines SL1˜SL2 and one of the data lines DL1˜DL3, respectively. Specifically, the active device T1 includes a gate G1, a source S1, and a drain D1. The gate G1 is electrically connected to the scan line SL1. The source S1 is electrically connected to the data line DL1. The active device T2 includes a gate G2, a source S2, and a drain D2. The gate G2 is electrically connected to the scan line SL2. The source S2 is electrically connected to the data line DL2. The active devices T1 and T2 can be bottom-gate thin film transistors (TFTs) or top-gate TFTs.

The pixel electrode PE1 is electrically connected to the active device T1. The pixel electrode PE2 is electrically connected to the active device T2. In particular, the pixel electrode PE1 is electrically connected to the drain D1 of the active device T1. The pixel electrode PE2 is electrically connected to the drain D2 of the active device T2. The pixel electrodes PE1 and PE2 can be transmissive pixel electrodes, reflective pixel electrodes, or transflective pixel electrodes. A material of the transmissive pixel electrodes includes metal oxide, such as indium tin oxide (ITO), indium zinc oxide (IZO), aluminum tin oxide (ATO), aluminum zinc oxide (AZO), indium germanium zinc oxide (IGZO), other suitable oxide, or a layer in which at least two of the above materials are stacked together. A material of the reflective pixel electrodes includes a metallic material with high reflectivity.

In this embodiment, the pixel electrodes PE1 and PE2 and the data lines DL1˜DL3 are not overlapped. It should be mentioned that the photo-masks used to define the pixel electrodes PE1 and PE2 of the pixel structures and the photo-masks used to define the data lines DL1˜DL3 are often designed to make the distance between the pixel electrodes and the data lines located at the respective sides of the pixel electrodes equal. However, during actual fabrication, misalignment between the photo-masks and the layers leads to the fact that the distance between the pixel electrodes and the data lines located at the respective sides of the pixel electrodes cannot be equal. Hence, the distance between the pixel electrodes and the data lines located at the respective sides of the pixel electrodes is not the same in most cases. For instance, as shown in FIG. 1, a first distance d1 and a second distance d2 are between the pixel electrode PE1 and the data lines DL1 and DL2 located at the respective sides of the pixel electrode PE1, and the first distance d1 is in general not equal to the second distance d2. Since the first distance d1 and the second distance d2 that are between the pixel electrode PE1 and the data lines DL1 and DL2 located at the respective sides of the pixel electrode PE1 are different, the coupling capacitance between the pixel electrode PE1 and the data lines DL1 and DL2 located at the respective sides of the pixel electrode PE1 is different. In order to reduce the difference in the coupling capacitance between the pixel electrodes and the data lines located at the respective sides of the pixel electrodes, conductive bar patterns are configured on the data lines in this embodiment, as described hereinafter.

The conductive bar patterns B1˜B3 are respectively located on the data lines DL1˜DL3 and electrically connected to the corresponding data lines DL1˜DL3. In this embodiment, an insulating layer 104 is sandwiched between the data lines DL1˜DL3 and the conductive bar patterns B1˜B3, and the data lines DL1˜DL3 and the conductive bar patterns B1˜B3 are electrically connected through contact windows C1˜C3 formed in the insulating layer 104. To be more specific, the conductive bar pattern B1 is located on the data line DL1 and is electrically connected to the data line DL1 through the contact window C1 formed in the insulating layer 104. The conductive bar pattern B2 is located on the data line DL2 and is electrically connected to the data line DL2 through the contact window C2 formed in the insulating layer 104. The conductive bar pattern B3 is located on the data line DL3 and is electrically connected to the data line DL3 through the contact window C3 formed in the insulating layer 104. The number of the contact windows C1˜C3 electrically connected between the conductive bar patterns B1˜B3 and the data lines DL1˜DL3 is not limited in this invention. For instance, the number of the contact window C1 electrically connected between the conductive bar pattern B1 and the data line DL1 can be one, two, or more. In addition, the conductive bar patterns B1-B3 and the data lines DL1˜DL3 are not restricted to be electrically connected through the contact windows C1˜C3 in this invention. Namely, in other embodiments of the invention, the conductive bar patterns B1˜B3 can be directly in contact with the data lines DL1˜DL3.

The line width of the conductive bar patterns B1˜B3 is greater than or equal to the line width of the data lines DL1˜DL3. According to the embodiment depicted in FIG. 1, the line width of the conductive bar patterns B1˜B3 is greater than the line width of the data lines DL1˜DL3. A ratio W1/W2 of the line width W1 of the conductive bar patterns B1˜B3 to the line width W2 of the data lines DL1˜DL3 is approximately 1˜1.5 according to an embodiment of the invention.

In this embodiment, the conductive bar patterns B1˜B3 and the pixel electrodes PE1 and PE2 are in the same layer. Preferably, the conductive bar patterns B1˜B3 and the pixel electrodes PE1 and PE2 are made of the same material. A method of forming the conductive bar patterns B1˜B3 and the pixel electrodes PE1 and PE2 in this embodiment includes depositing a conductive layer (not shown) and patterning the conductive layer by performing a photolithography and etching process, so as to simultaneously define the conductive bar patterns B1˜B3 and the pixel electrodes PE1 and PE2. Given the pixel electrodes PE1 and PE2 are made of a transparent conductive material, the conductive bar patterns B1˜B3 are also made of the transparent conductive material. Similarly, given the pixel electrodes PE1 and PE2 are made of a reflective metallic material, the conductive bar patterns B1˜B3 are also made of the reflective metallic material.

Based on the above, even though the misalignment between the pixel electrodes PE1 and PE2 and the data lines DL1˜DL3 leads to the fact that the distance between the pixel electrodes PE1 and PE2 and the data lines DL1˜DL3 located at the respective sides of the pixel electrodes PE1 and PE2 is not equal, the conductive bar patterns B1˜B3 and the pixel electrodes PE1 and PE2 are defined at the same time. Accordingly, the distance between the pixel electrodes PE1 and PE2 and the conductive bar patterns B1˜B3 located at the respective sides of the pixel electrodes PE1 and PE2 is still the same. In conclusion, the conductive bar patterns B1˜B3 configured on the data lines DL1˜DL3 can reduce the difference in the coupling capacitance between the pixel electrodes and the data lines located at the respective sides of the pixel electrodes.

In detail, as shown in FIG. 1, the coupling capacitance is generated between the pixel electrode PE1 and the data lines DL1 and DL2 located at the respective sides of the pixel electrode PE1, and the coupling capacitance is also generated between the pixel electrode PE1 and the conductive bar patterns B1 and B2 located at the respective sides of the pixel electrode PE1. Hence, the coupling capacitance Cpd-L between the pixel electrode PE1 and the data line DL1 and the coupling capacitance Cpc-L between the pixel electrode PE1 and the conductive bar pattern B1 together contribute to the coupling capacitance C-L at the left side of the pixel electrode PE1. The coupling capacitance Cpd-R between the pixel electrode PE1 and the data line DL2 and the coupling capacitance Cpc-R between the pixel electrode PE1 and the conductive bar pattern B2 together contribute to the coupling capacitance C-R at the right side of the pixel electrode PE1. When the first distance d1 between the pixel electrode PE1 and the data line DL1 is greater than the second distance d2 between the pixel electrode PE1 and the data line DL2, the coupling capacitance Cpd-L between the pixel electrode PE1 and the data line DL1 is smaller than the coupling capacitance Cpd-R between the pixel electrode PE1 and the data line DL2. However, since the conductive bar patterns B1 and B2 and the pixel electrode PE1 are defined at the same time, the distance between the pixel electrode PE1 and the conductive bar patterns B1 and B2 located at the respective sides of the pixel electrode PE1 is still the same. In other words, the coupling capacitance Cpc-L between the pixel electrode PE1 and the conductive bar pattern B1 is the equal to the coupling capacitance Cpc-R between the pixel electrode PE1 and the conductive bar pattern B2. Thereby, the difference between the coupling capacitance C-L at the left side of the pixel electrode PE1 and the coupling capacitance C-R at the right side of the pixel electrode PE1 can be reduced.

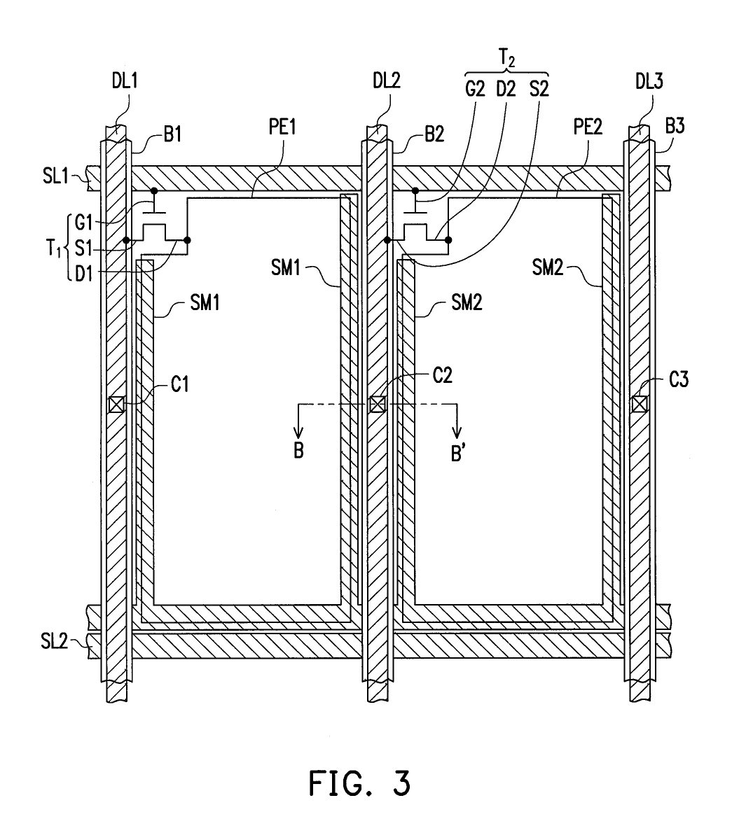

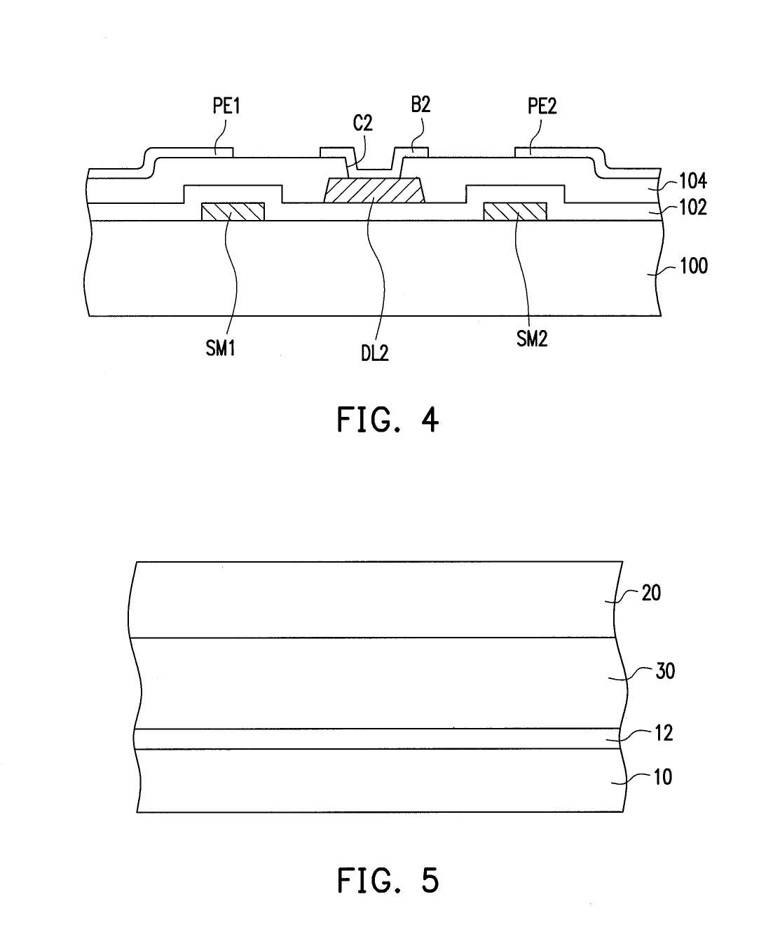

FIG. 3 is a schematic top view illustrating a pixel array according to an embodiment of the invention. FIG. 4 is a schematic cross-sectional view taken along a sectional line B-B′ depicted in FIG. 3. With reference to FIG. 3 and FIG. 4, the embodiment shown in FIG. 3 (FIG. 4) is similar to the embodiment shown in FIG. 1 (FIG. 2), and thus identical components in FIG. 3 (FIG. 4) and in FIG. 1 (FIG. 2) will be denoted with the same numerals and will not be further described herein. The difference between the embodiment shown in FIG. 3 (FIG. 4) and the embodiment shown in FIG. 1 (FIG. 2) lies in that the pixel array of this embodiment further includes a plurality of shielding patterns SM1 and SM2. The shielding patterns SM1 and SM2 are located between the data lines DL1˜DL3 and the pixel electrodes PE1 and PE2, and the shielding patterns SM1 and SM2 are electrically insulated from the data lines DL1˜DL3.

As indicated in FIG. 3, the shielding pattern SM1 is located between the data line DL1 and the pixel electrode PE1 and between the data line DL2 and the pixel electrode PE1. The shielding pattern SM2 is configured between the data line DL2 and the pixel electrode PE2 and between the data line DL3 and the pixel electrode PE2. According to this embodiment, the shielding patterns SM1 and SM2 and the scan lines SL1 and SL2 are in the same layer and are made of the same material. Besides, the shielding patterns SM1 and SM2 are located on the substrate 100 and covered by the insulating layers 102 and 104. However, the invention is not limited thereto. According to other embodiments of the invention, the shielding patterns SM1 and SM2 can also be in other layers.

Additionally, the shielding patterns SM1 and SM2 are electrically connected to the common voltage Vcom. Namely, the shielding patterns SM1 and SM2 are electrically insulated from not only the scan lines SL1 and SL2 but also the data lines DL1˜DL3.

In this embodiment, the shielding patterns SM1 and SM2 are configured between the data lines DL1˜DL3 and the pixel electrodes PE1 and PE2 and electrically connected to the common voltage Vcom. Therefore, the shielding patterns SM1 and SM2 can reduce the coupling capacitance between the data lines DL1˜DL3 and the pixel electrodes PE1 and PE2.

As described above, the conductive bar patterns B1˜B3 configured on the data lines DL1˜DL3 can reduce the difference in the coupling capacitance between the pixel electrodes PE1 and PE2 and the data lines DL1˜DL3 located at the respective sides of the pixel electrodes PE1 and PE2. The shielding patterns SM1 and SM2 are further configured between the data lines DL1˜DL3 and the pixel electrodes PE1 and PE2 in this embodiment, so as to reduce the coupling capacitance between the data lines DL1˜DL3 and the pixel electrodes PE1 and PE2. Hence, by configuring the conductive bar patterns B1˜B3 and the shielding patterns SM1 and SM2, the difference in the coupling capacitance between the pixel electrodes PE1 and PE2 and the data lines DL1˜DL3 located at the respective sides of the pixel electrodes PE1 and PE2 can be further reduced.

FIG. 5 is a schematic view illustrating a display panel according to an embodiment of the invention. As shown in FIG. 5, the display panel of this embodiment includes a first substrate 10, a second substrate 20, and a display medium 30.

The first substrate 10 includes a pixel array 12. Here, the pixel array 12 can be the pixel array shown in FIG. 1 or FIG. 3.

The second substrate 20 is located opposite to the first substrate 10. An electrode layer (not shown) can be further configured on the second substrate 20. The electrode layer is a transparent conductive layer, and a material of the electrode layer includes metal oxide, e.g., ITO or IZO. Besides, the electrode layer fully covers the second substrate 20. On the other hand, a color filter array (not shown) including red, green, and blue color filter patterns can be further formed on the second substrate 20 according to another embodiment of the invention. Moreover, a light shielding pattern layer (not shown), which is also referred to as a black matrix, can be further configured on the second substrate 20 and arranged between the patterns of the color filter array.

The display medium 30 is sandwiched between the first substrate 10 and the second substrate 20. Here, the display medium 30 can include liquid crystal molecules, an electrophoretic display medium, or any other suitable display medium.

In light of the foregoing, the pixel array of the first substrate 10 in the display panel of this embodiment can be the pixel array shown in FIG. 1 or FIG. 3. In the pixel array depicted in FIG. 1 or FIG. 3, the conductive bar patterns are located on and electrically connected to the data lines. Since the conductive bar patterns and the data lines have the same voltage level, and the conductive bar patterns and the pixel electrodes are defined at the same time, the difference in the coupling capacitance at the respective sides of the pixel electrodes can be reduced, and the V-crosstalk effects of the display panel can be further mitigated.

It will be apparent to those skilled in the art that various modifications and variations can be made to the invention without departing from the scope or spirit of the invention. In view of the foregoing, it is intended that the invention cover modifications and variations of this invention provided they fall within the scope of the following claims and their equivalents.

What is claimed is:

1. A pixel structure comprising:
a scan line and a data line;
an active device electrically connected to the scan line and the data line;
a pixel electrode electrically connected to the active device; and
a conductive bar pattern located on and electrically connected to the data line, wherein the conductive bar pattern has a line width greater than or equal to a line width of the data line, and the conductive bar pattern and the pixel electrode are in a same layer.

2. The pixel structure as claimed in claim 1, wherein a ratio of the line width of the conductive bar pattern to the line width of the data line is approximately 1˜1.5.

3. The pixel structure as claimed in claim 1, wherein a material of the conductive bar pattern is the same as a material of the pixel electrode.

4. The pixel structure as claimed in claim 1, wherein the pixel electrode and the data line are not overlapped.

5. The pixel structure as claimed in claim 1, further comprising an insulating layer located between the data line and the conductive bar pattern, the insulating layer having a contact window electrically connected to the data line and the conductive bar pattern.

6. The pixel structure as claimed in claim 1, further comprising a shielding pattern located between the data line and the pixel electrode, the shielding pattern being electrically insulated from the data line.

7. The pixel structure as claimed in claim 6, wherein the shielding pattern is electrically connected to a common voltage.

8. A pixel array comprising:
a plurality of data lines and a plurality of scan lines;
a plurality of active devices, each of the active devices being electrically connected to one of the scan lines and one of the data lines;
a plurality of pixel electrodes, each of the pixel electrodes being electrically connected to one of the active devices; and
a plurality of conductive bar patterns, each of the conductive bar patterns being located on and electrically connected to one of the data lines, wherein the conductive bar patterns have a line width greater than or equal to a line width of the data lines, and the conductive bar patterns and the pixel electrodes are in a same layer.

9. The pixel array as claimed in claim 8, wherein a ratio of the line width of the conductive bar patterns to the line width of the data lines is approximately 1˜1.5.

10. The pixel array as claimed in claim 8, wherein a material of the conductive bar patterns is the same as a material of the pixel electrodes.

11. The pixel array as claimed in claim 8, wherein each of the data lines and the pixel structures located at respective sides of the each of the data lines are not overlapped.

12. The pixel array as claimed in claim 8, wherein a first distance and a second distance are between each of the data lines and the pixel electrodes located at respective sides of the each of the data lines, and the first distance is not equal to the second distance.

13. The pixel array as claimed in claim 8, further comprising an insulating layer located between the data lines and the conductive bar patterns, the insulating layer having a plurality of contact windows electrically connected to the data lines and the conductive bar patterns.

14. The pixel array as claimed in claim 8, further comprising a plurality of shielding patterns located between the data lines and the pixel electrodes and electrically insulated from the data lines.

15. The pixel array as claimed in claim 14, wherein the shielding patterns are electrically connected to a common voltage.

16. A display panel comprising:
a first substrate having the pixel array as claimed in claim 8;
a second substrate located opposite to the first substrate; and
a display medium located between the first substrate and the second substrate.
